(19) United States
(12) Patent Application Publication
(10) Pub. No.: US 2013/0057197 A1
(43) Pub. Date: Mar. 7, 2013

(54) ELECTRIC GENERATOR

(71) Applicant: Domingo Martin Ramos, Villamayor (Salamanca) (ES)

(72) Inventor: Domingo Martin Ramos, Villamayor (Salamanca) (ES)

(21) Appl. No.: 13/697,187

(22) PCT Filed: Oct. 21, 2010
(86) PCT No.: PCT/ES2010/070676

§ 371 Date: Nov. 9, 2012

(30) Foreign Application Priority Data
May 17, 2010 (ES) U201030477

(51) Int. Cl. H02N 6/00; H02J 7/00

(52) U.S. Cl. 320/101

(57) ABSTRACT

The invention relates to a generator that consists of a thin casing having two main opposite walls, one of which is largely occupied by a photovoltaic cell panel (1) facing a system of diode-based (2) lighting, either light emitting diodes (LED) or organic light emitting diodes (OLED). Both the photovoltaic cell panel and the lighting system are associated with a battery or electric accumulation system such that said element supplies the lighting system, and is also supplied through the appropriate circuitry by the photovoltaic cell panel (1) the light emitted being transformed into energy.

### PURPOSE OF THE INVENTION

The invention relates to a device for generating electricity, based on renewable energy.

The purpose of the invention is to provide an electric generator, which based on the aforementioned renewable energy, has a novel structure that makes its operation totally independent from existing weather conditions.

Therefore, the invention is within the field of renewable energy.

### HISTORY OF THE INVENTION

In the field of the practical application of the invention, numerous means for generating non-polluting electrical energy are known, such as water-powered turbines, wind turbines, photovoltaic cell panels, among others.

The common problem of these types of devices is that they depend on nature, making their autonomy is limited.

Thus, for example, water turbines are limited by the existence of running water, which due to constant drought conditions, cannot always be guaranteed.

The same can be said for wind and photovoltaic energy, which is limited by the existence of wind and sunlight respectively.

Therefore, these technologies are not always as adequate as required.

### DESCRIPTION OF THE INVENTION

The electric generator proposed in the invention successfully solves the aforementioned problems with a configuration that makes it totally independent from weather conditions, presenting a novel structure that make it easy to integrate into all types of devices and elements, such as homes, automobiles and any electrical device.

More specifically, the device presented consists of a casing that can have diverse configurations, in accordance with the flexible nature of the devices that it will hold, but in any case it will always have a thin casing with two main opposite parallel walls with a certain distance between each other.

One of the walls is largely occupied by a photovoltaic cell panel whose working side faces the inside of the casing, while the opposite side will have a panel, formally and dimensionally the same as the dimensions of the photovoltaic cells, with cells that have a system of diode-based lighting, either light emitting diodes (LED) or preferably organic light emitting diodes (OLED), creating an electroluminescent layer formed by a film of organic components that react to a certain electrical stimulation, generating and transmitting light by themselves.

The inside surface of the casing will be covered with mirrors or any reflective material, so as to maximise the usage of the light emitted by the lighting system to the photovoltaic cells.

As both OLED lighting systems and certain types of photovoltaic cell panels can be placed on curved surfaces, the casing of the invention can be designed to adapt to a wide variety of elements that need a source of energy, such as for example to be built into the doors of a vehicle, the possibilities being almost infinite.

The lighting system will be connected to an electric accumulator battery to start up, while the photovoltaic cell panel will be used to charge this battery.

As the diode lighting generates light similar to solar, this light will be used by the photovoltaic cell panel to generate electric energy, appreciably more than the low consumption of this type of illumination, with the possibility of making use of the surplus energy, for which the device will have a corresponding circuitry to adapt the current to the voltage levels necessary in each case.

To optimise the performance of the device, the sides of the casing will have a series of ventilation openings, if necessary.

Although the diodes generate very little heat, if the conditions require it, these ventilation openings may be fitted with micro-fans to ensure long life of the device.

Finally, the casing can have a wide variety of external finishes, depending on the type of implementation, simulating wood, stone, grass, plaster, metal, mirror, etc.

As the photovoltaic cell panel is not affected by adverse weather, the service life of the device is significantly longer than a conventional photovoltaic panel.

### DESCRIPTION OF THE ILLUSTRATIONS

To complement this description and for a better understanding of the features of the invention, this descriptive report is accompanied by an illustration as an integral part of the same, which for illustrative purposes includes but is not limited to the following:

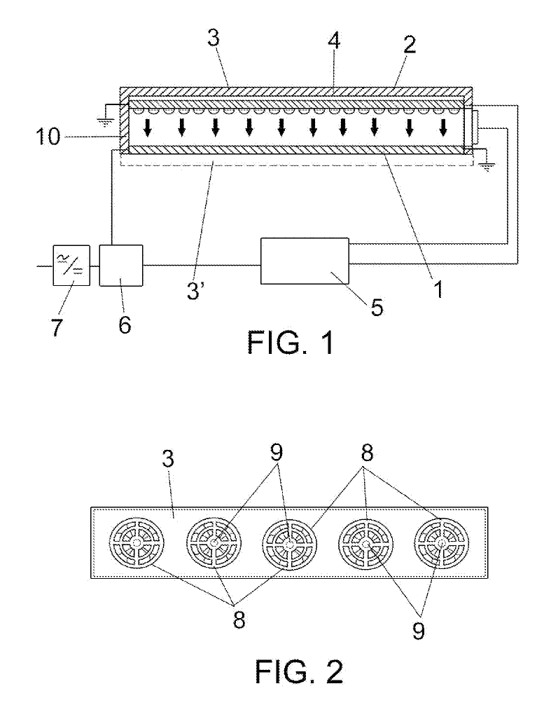

FIG. 1.—Shows a schematic section view of an electric generator made in accordance with the object of this invention.

FIG. 2.—Shows a profile view of the above figure.

### PREFERRED IMPLEMENTATION OF THE INVENTION

In view of the above figures, especially FIG. 1, it can be seen how the electric generator described has a photovoltaic cell panel (1) opposite a diode-based lighting system (2), either using light emitting diodes (LED) or organic light emitting diodes (OLED), elements that are built into the casing (3), the photovoltaic cell panel (1) can constitute the back of the casing, if it is rigid, or have a back (3′) on which the photovoltaic cell panel rests (1) if it is flexible, in which case, the diode lighting system (2) will be the same, the casing (3) can adopt any curved shape, while both elements are conveniently opposite each other and parallel.

The diode-based lighting system (2) will be slightly separated from the upper wall of the casing (3), creating a space (4) for cooling the circuits.

The diode-based lighting system (2) will be connected to a battery (5) or an electric accumulation system, initially responsible for supplying this system, supply that once started, will be carried out directly, through the battery by means of the energy generated by the photovoltaic cell panel (1), with a voltage regulator between them (6) to adapt the voltage levels to the battery voltage, using the surplus energy for any electrical use desired, for which purpose the circuit may have a transformer (7) to convert the DC current generated by the photovoltaic cell panel (1) into AC current, at the required voltage.

As can be seen in FIG. 2, the casing can have ventilation openings on its smaller sides (8), and these can be assisted with micro-fans (9) powered from the battery (5).

To make better use of the light generated by the diode lighting system (2), the internal surfaces (10) of the casing (3) will be coated with a reflective finish such as mirrors, metal foil or similar materials.

Finally, as mentioned above, the casing (3) can have a very wide variety of finishes so it can be integrated into different places.

1. An electric generator, characterised by having a thin casing with two main opposite walls, one of which is largely occupied by a photovoltaic cell panel (1) opposite which is the other wall with a diode-based (2) lighting system, either using light emitting diodes (LED) or organic light emitting diodes (OLED), both elements being associated with a battery or electric accumulation system such that said element supplies the lighting system and is also supplied through the appropriate circuitry by the photovoltaic cell panel (1).

2. An electric generator as in claim 1, characterised by the fact that the photovoltaic cell panel (1) can form one of the walls or the back of the casing.

3. An electric generator as in claim 1, characterised by the fact that the LED or OLED diode-based lighting system is slightly separated from the corresponding wall of the casing (3), creating a space (4) for cooling the circuits.

4. An electric generator as in claim 1, characterised by the fact that between the photovoltaic cell panel (1) and the battery, there is a voltage regulator (6) that adapts the voltage levels to the battery voltage, incorporating a transformer (7) to adapt the DC current generated by the photovoltaic cell panel (1) to AC current and at the necessary voltage.

5. An electric generator as in claim 1, characterised by the fact that the casing has ventilation openings on its smaller sides (8).

6. An electric generator as in claim 5, characterised by the fact that the casing openings are assisted by micro-fans (9) powered by the battery (5).

7. An electric generator as in claim 1, characterised by the fact that the internal surface (10) of the casing (3) is coated with reflective material.

8. An electric generator as in claim 1, characterised by the fact that the aforementioned casing can have different external finishes, according to its application and planned implementation, simulating wood, stone, grass, plaster or others.
